(19) United States
(12) Patent Application Publication
(10) Pub. No.: US 2026/0058508 A1
(43) Pub. Date: Feb. 26, 2026

(54) ROTOR CARRIER FOR A ROTOR DEVICE OF AN ELECTRIC MACHINE AND METHOD FOR PRODUCING A POSITIONING MEANS IN A ROTOR CARRIER

(71) Applicant: Schaeffler Technologies AG & Co. KG, Herzogenaurach (DE)

(72) Inventor: Stephan Maienschein, Baden-Baden (DE)

(73) Assignee: Schaeffler Technologies AG & Co. KG, Herzogenaurach (DE)

(21) Appl. No.: 19/100,121

(22) PCT Filed: Jul. 24, 2023
(86) PCT No.: PCT/DE2023/100541

§ 371 Date: Jan. 31, 2025

(30) Foreign Application Priority Data
Aug. 1, 2022 (DE) 10 2022 119 229.6

(51) Int. Cl. H02K 1/22; H02K 15/021

(52) U.S. Cl. CPC H02K 1/22; H02K 15/021

(57) ABSTRACT

A rotor carrier for a rotor of an electric machine includes a rotation axis, a flange connection portion arranged for connecting to a rotor shaft; and a receiving section arranged for receiving laminated cores. The receiving section includes a laminated core holder arranged for non-rotatably holding the laminated cores, an axial stop arranged for limiting axial movement of the laminated cores, and a positioning device for relative alignment of the laminated cores on the laminated core holder. The positioning device includes a first groove comprising a first circumferential width, and a second groove, axially aligned with the first groove and comprising a second circumferential width, different that the first circumferential width. A rotor device, an electric machine, and a method for producing a positioning means in a rotor carrier are also disclosed.

### CROSS-REFERENCE TO RELATED APPLICATIONS

This application is the United States National Phase of PCT Appln. No. PCT/DE2023/100541 filed Jul. 24, 2023, which claims priority to German Application No. DE102022119229.6 filed Aug. 1, 2022, the entire disclosures of which are incorporated by reference herein.

### TECHNICAL FIELD

The present disclosure relates to a rotor carrier for a rotor device of an electric machine of an electric or hybrid vehicle, a rotor device for an electric machine of an electric or hybrid vehicle and an electric machine for an electric or hybrid vehicle with a rotor device. The disclosure further relates to a method for producing a positioning means in a rotor carrier.

### BACKGROUND

Known electric machines for an electric or hybrid vehicle include a rotor device, with which rotational energy can be generated or which can serve as part of a generator.

A rotor device includes, for example, a rotor carrier having a receiving section for laminated cores. A rotor laminated core or laminated core is arranged on the receiving section.

For correct alignment and also for assembly purposes, the rotor carrier or its receiving section has a positioning means, which is designed as a groove and into which a positioning means of the laminated core in the form of a nose can engage.

The groove has been milled into the receiving section of the rotor carrier using a single milling tool and extends in the axial direction. The milling process creates a burr that has to be laboriously removed after milling, because the geometry of the groove must remain unchanged during deburring in order to ensure that the laminated cores are fixed and positioned. Furthermore, during the milling process, metallic particles, for example, can be released in the area of the magnetized rotor device. These metallic particles can then penetrate, for example, into a gap between the rotor device and a stator device of the electrical machine.

### SUMMARY

The present disclosure provides a rotor carrier for a rotor device of an electric machine of an electric or hybrid vehicle, a rotor device for an electric machine of an electric or hybrid vehicle and an electric machine for an electric or hybrid vehicle with a rotor device, which can be produced cost-effectively and in a material-saving manner and which solves the above-mentioned problem or ensures deburring of a groove in a simple manner.

Furthermore, the present disclosure also provides a method for producing a positioning means in a rotor carrier, which ensures cost-effective and material-saving production and solves the problem outlined above or allows deburring of a groove in a simple manner.

A first aspect of the present disclosure features a rotor carrier for a rotor device of an electric machine of an electric or hybrid vehicle.

The rotor carrier includes a flange connection portion for connection to a flange means of a shaft of a rotor device and a receiving section for laminated cores. The receiving section can be arranged furthest away from a rotation axis in the radial direction. The flange connection portion can be arranged closest to the rotation axis.

The connection portion may connect the flange connection portion with the receiving section. The flange connection portion and the receiving section can, for example, be arranged directly next to one another.

Furthermore, the receiving section can be divided into two areas. Thus, the receiving section can include a receiving region for receiving laminated cores and a connecting region for connecting the flange connection portion to the receiving section. The connecting region may connect the flange connection portion with the receiving region.

The receiving section or its receiving region has a laminated core holder for non-rotatable arrangement of laminated cores and an axial stop for limiting a movement of laminated cores in the axial direction.

Furthermore, the receiving section has at least one positioning means for the relative alignment of laminated cores on the laminated core holder.

The at least one positioning means includes two grooves, which are designed with different dimensions or widths in the circumferential direction. The two grooves are arranged so as to be aligned in the axial direction. In the present description, the term “aligned” can be understood to mean an arrangement of the two grooves along a common straight center line, and the center line can extend in the middle between the two edges of the grooves. By designing the at least one positioning means with the aid of two grooves, the time-consuming deburring of a positioning means designed as a groove can be prevented. On the one hand, by creating a larger groove, deburring of the smaller groove can be eliminated or integrated into the milling operation, whereby the deburring of the larger groove after creating the smaller groove can be easily done with the tool that was used to create the smaller groove.

Furthermore, the at least one positioning means can have a first and a second groove.

The first groove, when viewed in the circumferential direction, can have a first width and the second groove, when viewed in the circumferential direction, can have a second width, and the first groove can be wider than the second groove. The first groove eliminates the need to deburr the second groove, although the first groove can be deburred more easily as it is wider.

Furthermore, when viewed in the radial direction, a bottom of the first groove can have a greater distance from the rotation axis of the rotor carrier than a bottom of the second groove. In other words, when viewed in the radial direction, a first distance between a bottom of the first groove and the rotation axis can be greater than a second distance between a bottom of the second groove and the rotation axis. Thus, the second groove is formed deeper in the rotor carrier in the radial direction than the first groove. A step can form at the transition from the first to the second groove.

Furthermore, a first groove of the at least one positioning means can be arranged within the axial stop. This makes it possible to create a groove with two straight edges along a laminated core holder of the receiving section.

The first groove in a plane, formed from the circumferential direction and the axial direction, can have a shape similar to a circular segment or similar to a semicircle. This shape is created when the groove is produced using a milling tool.

The first groove can also reduce the outer diameter of the laminated core holder of the receiving section of the rotor carrier by 0.05 to 0.5 mm, so that, in preparation for the second groove, a plateau can be created on the outer side of the laminated core holder, which, in comparison to the outer side of the laminated core holder, has a distance from the rotation axis, which can be smaller by a burr created during the production of the second groove. This eliminates the need for deburring after the second groove has been produced.

Furthermore, the second groove can be positioned relative to the first groove such that, in the axial direction and/or circumferential direction, the second groove extends and/or ends at least partially within the first groove.

The second groove can also be positioned relative to the first groove such that the end of the second groove, which has a shape similar to a segment of a circle or similar to a semicircle, is arranged completely within the first groove when viewed in the axial direction. Thus, in the axial direction, the second groove within the laminated core holder forms two straight edges or only two straight edges. Consequently, maximum space is created for a positioning means of a laminated core.

In addition, the first groove can remove material from the axial stop. The first groove can have been formed by means of a first milling tool, the rotation axis of which is aligned in the radial direction and which may have been moved in the axial direction into the axial stop or into a surface of the axial stop which is aligned in the same direction as the radial direction.

In addition, a second groove of the at least one positioning means can be arranged within the laminated core holder. The second groove can have in a plane, formed by the circumferential direction and the axial direction, at least partially a shape similar to an elongated hole.

The second groove can also remove material from the laminated core holder. The second groove can have been formed by means of a second milling tool, the rotation axis of which is aligned in the radial direction and which can have been moved in the axial direction into the laminated core holder.

Finally, it should be noted that the rotor carrier can be constructed in one piece.

A second aspect of the present disclosure includes a rotor device for an electric machine of an electric or hybrid vehicle.

It is expressly noted that the features of the rotor carrier as mentioned in the first aspect of the disclosure may find application in the rotor device, both individually or in combination with one another.

In other words, the features mentioned above under the first aspect of the disclosure concerning the rotor carrier can also be combined with other features under the second aspect of the disclosure.

Accordingly, a rotor device for an electric machine of an electric or hybrid vehicle includes a rotor carrier according to the first aspect.

Furthermore, the rotor device includes a shaft having a flange means for connection to the flange connection portion of the rotor carrier. The shaft can be used to connect to an electrical machine and/or an internal combustion engine.

In addition, the rotor device can include a laminated core, having a positioning means for arrangement in a positioning means of the rotor carrier. A magnetic field can be amplified using the laminated core.

The positioning means of the laminated core can be designed in the form of a nose. Furthermore, the laminated core with its positioning means is arranged within the second groove of the rotor carrier or within the at least one positioning means of the rotor carrier. Thus, the positioning means of the laminated core, designed as a nose, can engage in a positioning means of a receiving section of the rotor carrier, designed as a second groove, in order to prevent a relative rotation of the laminated core and the rotor carrier.

Furthermore, the flange means of the shaft is connected to the flange connection portion of the rotor carrier. The flange means of the shaft can also be integrally connected to the flange connection portion of the rotor carrier, for example by welding.

In addition, the rotor device can have a torsion damper, which can be arranged on the rotor carrier. This can be useful, for example, in a P1 or P2 hybridization.

A third aspect of the present disclosure includes an electric machine for an electric or hybrid vehicle.

Reference is explicitly made to the fact that the features of the rotor device, as mentioned under the second aspect, can be used individually or in combination with one another in the electrical machine.

In other words, the features mentioned above under the second aspect of the disclosure relating to the rotor device can also be combined with further features described herein under the third aspect of the disclosure.

An electric machine for an electric or hybrid vehicle is equipped with a rotor device according to the second aspect and a stator device surrounding the rotor device.

A fourth aspect of the present disclosure includes a method of producing a positioning means in a rotor carrier.

Reference is explicitly made to the fact that the features of the rotor device, as mentioned under the second aspect, can be used individually or in combination with one another in the method for producing a positioning means in a rotor carrier.

In other words, the features mentioned above under the second aspect of the disclosure relating to the rotor device can also be combined with further features described herein under the fourth aspect of the disclosure.

A method for producing a positioning means in a rotor carrier for an electric machine of an electric or hybrid vehicle can include the following steps.

A first step comprises positioning a first milling tool relative to a rotor carrier at initial coordinates in the axial direction and circumferential direction.

The free end of the first milling tool is positioned at a first radial distance from the rotation axis of the rotor carrier.

The first radial distance can be 0.05 to 0.5 mm smaller than the outer diameter of a laminated core holder of a receiving section of the rotor carrier, so that, in preparation for a second groove, a plateau is created on the outer side of the laminated core holder, which, in comparison to the outer side of the laminated core holder, has a smaller distance from the rotation axis, so that deburring after the production of the second groove can be omitted.

A further step includes creating a first groove running in the axial direction, using the first milling tool. For this purpose, the first milling tool can only be moved in the axial direction.

The first groove is formed within an axial stop of a receiving section of the rotor carrier and/or the first groove forms a plateau on the outer side of a laminated core holder of the rotor carrier.

An additional step involves moving the first milling tool away from the rotor carrier and then changing the milling tool.

A next step includes positioning a second milling tool relative to the rotor carrier at the initial coordinates of the first milling tool in the axial direction and circumferential direction.

The free end of the second milling tool is positioned at a second, radial distance from the rotation axis of the rotor carrier. The second radial distance is smaller than the first radial distance.

This is followed, in a subsequent step, by creating a second groove running in the axial direction, using the second milling tool. For this purpose, the second milling tool can only be moved in the axial direction.

The second groove is formed within the laminated core holder of the receiving section of the rotor carrier and/or the second groove ends in the circumferential direction and axial direction within the first groove.

This is followed by the step of moving the second milling tool away from the rotor carrier. This step can complete the method for producing a positioning means in a rotor carrier for an electric machine of an electric or hybrid vehicle.

Furthermore, the first milling tool can have a first diameter and the second milling tool can have a second diameter, and the first diameter is larger than the second diameter. In this way, two grooves with different dimensions can be created in the circumferential direction.

Furthermore, when creating the first and second grooves, the first and second milling tools can be moved in the axial direction along the same path. This allows two grooves to be created, which are arranged so as to be aligned in the axial direction.

In addition, when creating the first and second groove, the first and second milling tools can approach the same end point in the circumferential direction and axial direction, so that the rotation axes of the milling tools end at the same coordinates in the circumferential direction and axial direction. This results in a step in the transition from the first groove to the second groove in a cross-section viewed in the radial and axial direction through the positioning means of the rotor carrier.

In addition, deburring the edges of the first and/or second groove can use the second milling tool.

When deburring the first groove in the circumferential direction, the second milling tool can remove one or more burrs at the transition from a surface of the axial stop, which is aligned in the same direction as the radial direction, into the first groove.

Alternatively or additionally, it is also possible to deburr the edges of the first and/or second groove using a third milling tool. The third milling tool can be a chamfer milling tool.

In the following, the disclosure described above is expressed again and in other words in a supplementary manner.

This idea concerns—in simplified terms—the groove connection geometry for a laminated core of a rotor carrier. In this case, a width measured in the circumferential direction can be designed differently in the casing area or in a receiving section for laminated cores of the rotor carrier and in the contact area or in the axial stop of a receiving section of the rotor carrier. In other words, a rotor carrier can have at least one positioning means with two grooves of different dimensions in the circumferential direction, wherein the two grooves are arranged so as to be aligned in the axial direction. This makes it possible to both create the geometry and deburr the machining edges in one machining center. An additional, downstream deburring process can thus be avoided. This can also reduce manufacturing costs and improve quality.

### BRIEF DESCRIPTION OF THE DRAWINGS

The present disclosure will be explained in more detail below using an exemplary embodiment in conjunction with associated drawings. In the schematic drawings:

FIG. 1 shows a sectional view of a rotor device for an electric machine of an electric or hybrid vehicle having a rotor carrier;

FIG. 2 shows an enlarged view from FIG. 1;

FIG. 3 shows a side view of FIG. 2 in the direction of arrow P in FIG. 2;

FIG. 4 shows a three-dimensional view of the rotor carrier from FIG. 1; and

FIG. 5 shows a sectional view of a rotor carrier during a manufacturing process.

### DETAILED DESCRIPTION

In the description below, the same reference symbols are used for the same components.

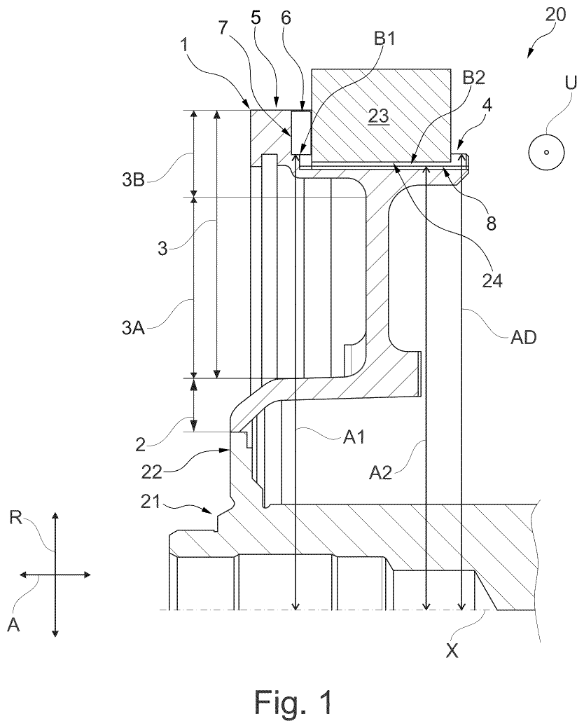

FIG. 1 shows a sectional view of a rotor device 20 for an electric machine of an electric or hybrid vehicle.

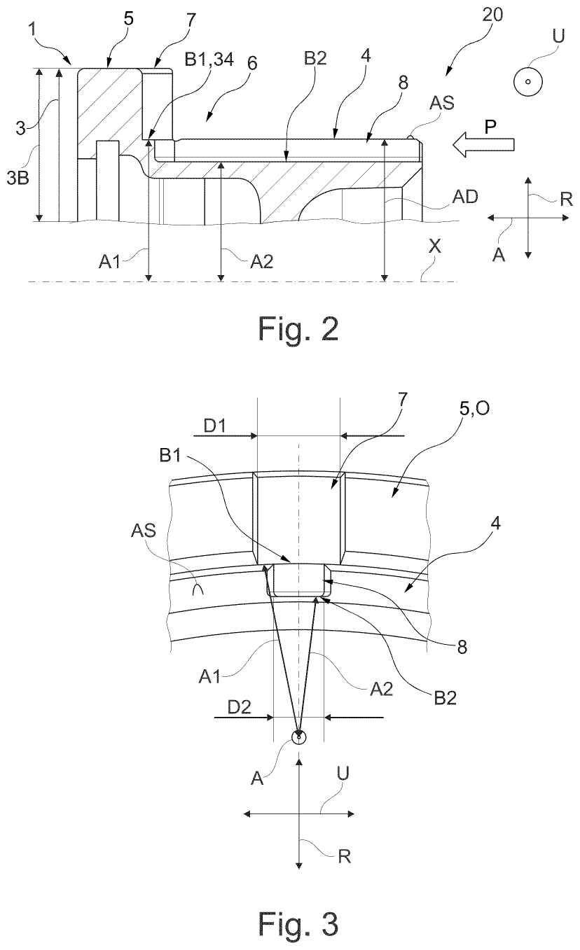

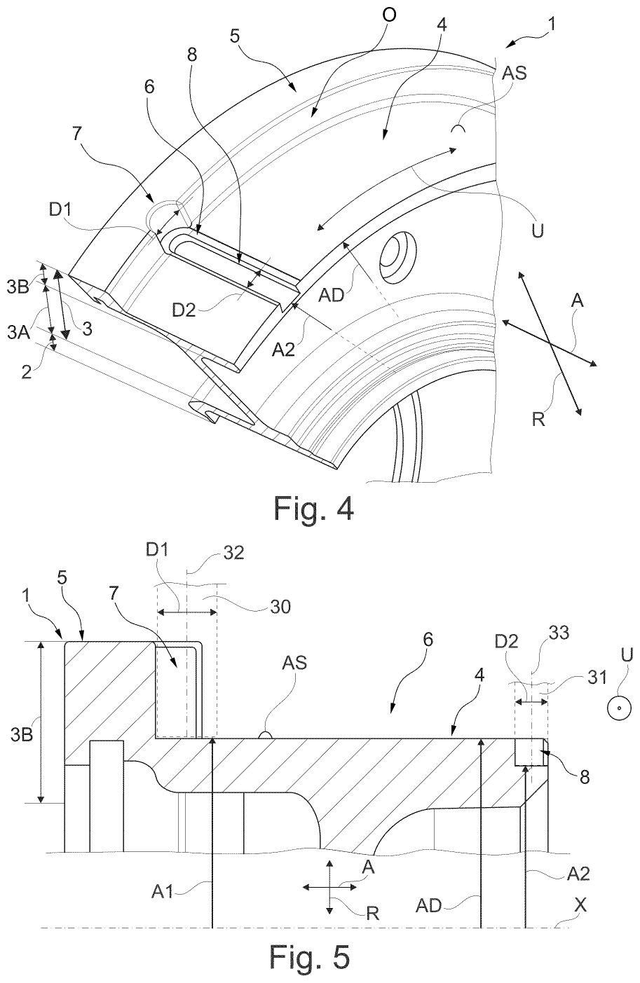

Furthermore, FIG. 2 shows an enlarged view of FIG. 1, FIG. 3 shows a side view of FIG. 2 in the direction of arrow P, and FIG. 4 shows a three-dimensional view of the rotor carrier of FIG. 1.

For the sake of simplicity and brevity, FIGS. 1 to 4 are described together below.

According to FIG. 1, the rotor device 20 includes a rotor carrier 1, which will be explained in more detail below, and a shaft 21 having a flange means 22 for connection to a flange connection portion 2 of the rotor carrier 1.

Furthermore, the rotor device 20 has a laminated core 23, having a positioning means 24 for arrangement in a positioning means 6 of the rotor carrier 1. The positioning means 24 of the laminated core 23 is designed in the form of a nose, and the laminated core 23 with its positioning means 24 is arranged within a second groove 8 of the rotor carrier 1.

The flange means 22 of the shaft 21 is integrally connected to the flange connection portion 2 of the rotor carrier 1.

Furthermore, as already mentioned, FIG. 1 shows a rotor carrier 1 for a rotor device 20 of an electric machine of an electric or hybrid vehicle.

Here, the rotor carrier 1 is formed in one piece and has a flange connection portion 2 for connection to the flange means 22 of the shaft 21 and a receiving section 3 for laminated cores 23. The flange connection portion 2 and the receiving section 3 are arranged directly next to each other.

Furthermore, FIG. 1 shows that the receiving section 3 can be divided into two regions 3A, 3B. Thus, the receiving section 3 includes a receiving region 3B for receiving laminated cores and a connecting region 3A for connecting the flange connection portion 2 to the receiving section 3B. The connecting region 3A connects the flange connection portion 2 with the receiving region 3B.

Furthermore, the receiving section 3 or its receiving region 3B has a laminated core holder 4 for non-rotatable arrangement of laminated cores 23 and an axial stop 5 for limiting a movement of laminated cores 23 in the axial direction A.

In addition, the receiving section 3 has a positioning means 6 for the relative alignment of laminated cores 23 on the laminated core holder 4.

As can be seen in FIGS. 1, 2, 3 and 4, the positioning means 6 includes two grooves 7, 8 which are formed with different widths in the circumferential direction U. The two grooves 7, 8—see FIGS. 3 and 4—are arranged so as to be aligned in the axial direction A. Thus, the two grooves 7, 8 are arranged along a common straight center line which extends in the middle between the two edges of the grooves 7, 8.

Described in more detail, the positioning means 6 has a first groove 7 and a second groove 8, and the first groove 7, when viewed in the circumferential direction U, has a first width D1 and the second groove 8, when viewed in the circumferential direction U, has a second width D2. The first groove 7 is wider than the second groove 8—see FIGS. 3 and 4.

It is also apparent from FIGS. 1 to 4 that, when viewed in the radial direction R, a bottom B1 of the first groove 7 has a greater distance Al from the rotation axis X of the rotor carrier 1 than a bottom B2 of the second groove 8. In other words, when viewed in the radial direction R, a first distance Al between a bottom B1 of the first groove 7 and the rotation axis X is greater than a second distance A2 between a bottom B2 of the second groove 8 and the rotation axis X.

Furthermore, FIGS. 1 to 4 show that the first groove 7 of the positioning means 6 is arranged within the axial stop 5.

According to FIG. 4, the first groove 7 in a plane, formed from the circumferential direction and the axial direction, has a shape similar to a circular segment or similar to a semicircle. In addition, the first groove 7 reduces the outer diameter AD of the laminated core holder 4 of the receiving section 3 of the rotor carrier 1 by 0.05 to 0.5 mm, so that, in preparation for the second groove 8, a plateau is created on the outer side AS of the laminated core holder 4. In comparison to the outer side AS of the laminated core holder 4, this plateau has a distance from the rotation axis X which is smaller by a burr created during the production of the second groove 8. This eliminates the need for deburring after the second groove 8 has been produced.

Furthermore, FIGS. 1 to 4 show that the second groove 8 is positioned relative to the first groove 7 such that, in the axial direction A and in the circumferential direction U, the second groove 8 runs and ends at least partially within the first groove 7.

The second groove 8 is positioned relative to the first groove 7 such that the end of the second groove 8, which has a shape similar to a segment of a circle or similar to a semicircle, is arranged completely within the first groove 7 when viewed in the axial direction A (see FIG. 4). Therefore, in the axial direction A, the second groove 8 within the laminated core holder 4 forms only two straight edges.

According to FIGS. 1 to 4, the first groove 7 receives material from the axial stop 5. As will be explained further below, the first groove 7 has been formed by means of a first milling tool 30, the rotation axis 32 of which is aligned in the radial direction R and which has moved into the axial stop 5 in the axial direction A.

The second groove 8 of the positioning means 6 is arranged within the laminated core holder 4, wherein the second groove 7 has in a plane, formed by the circumferential direction and the axial direction A, at least partially a shape similar to an elongated hole.

According to FIGS. 1 to 4, the second groove 8 receives material from the laminated core holder 4. As will be explained further below, the second groove 8 has been formed by means of a second milling tool 31, the rotation axis 33 of which is aligned in the radial direction R and which has been moved into the laminated core holder 4 in the axial direction A.

Finally, with regard to FIGS. 1 to 4, it should be mentioned that the rotor device 20 can also be part of an electrical machine. For example, an electric machine for an electric or hybrid vehicle can have the described rotor device 20 and a stator device that surrounds the rotor device 20.

FIG. 5 shows a sectional view of a rotor carrier 1 during a manufacturing process.

Strictly speaking, FIG. 5 shows a method for producing a positioning means 6 in a rotor carrier 1 for an electric machine of an electric or hybrid vehicle.

According to a first step, a first milling tool 30 is positioned relative to a rotor carrier 1 at initial coordinates in the axial and circumferential directions A, U.

The free end of the first milling tool 30 is positioned at a first radial distance A1 from the rotation axis X of the rotor carrier 1. The first radial distance is 0.05 to 0.5 mm smaller than the outer diameter AD of a laminated core holder 4 of a receiving section 3 of the rotor carrier 1. Thus, in preparation for a second groove 8, a plateau is created on the outer side AS of the laminated core holder 4, which, in comparison to the outer side AS of the laminated core holder 4, has a lesser distance from the rotation axis X. This eliminates the need for deburring after the second groove 8 has been produced.

This is followed by the step of creating a first groove 7 running in the axial direction A using the first milling tool 30. For this purpose, the first milling tool 30 is only moved in the axial direction A.

The first groove 7 is formed within an axial stop 5 of a receiving section 3 of the rotor carrier 1 and a plateau is formed on the outer side AS of a laminated core holder 4 of the rotor carrier 1.

Subsequently, the first milling tool 30 is moved away from the rotor carrier 1 and the milling tool is changed.

A second milling tool 31 is then positioned relative to the rotor carrier 1 at the initial coordinates of the first milling tool 31 in the axial and circumferential directions A, U. In addition, the free end of the second milling tool 31 is positioned at a second radial distance A2 from the rotation axis X of the rotor carrier 1. The second radial distance A2 is smaller than the first radial distance A1.

Subsequently, a second groove 8, which runs in the axial direction A, is created using the second milling tool 31. For this purpose, the second milling tool 31 is only moved in the axial direction A.

The second groove 8 is formed within the laminated core holder 4 of the receiving section 3 of the rotor carrier 1, and the second groove 8 ends in the circumferential direction U and axial direction A within the first groove 7.

The second milling tool 31 is then moved away from the rotor carrier 1.

As can be seen from FIG. 4, the first milling tool 30 has a first diameter D1 and the second milling tool 31 has a second diameter D2, and the first diameter D1 is larger than the second diameter D2.

Strictly speaking, when creating the first and second grooves 7, 8, the first and second milling tools 30, 31 are moved in the axial direction A along the same path. Thus, the two grooves 7, 8 are arranged so as to be aligned.

Furthermore, when creating the first and second grooves 7, 8, the first and second milling tools 30, 31 move to the same end point in the circumferential direction U and axial direction A. The rotation axes 32, 33 of the milling tools 30, 31 therefore end at the same coordinates in the circumferential direction U and axial direction A, which results in a step 34 in the transition from the first groove 7 to the second groove 8 in a cross-section viewed in the radial and axial direction R, A through the positioning means 6 of the rotor carrier 1 (see e.g. FIG. 2).

Following the creation of the first and second grooves 7, 8, the edges of the first and second grooves 7, 8 are deburred using the second milling tool 31.

When deburring the first groove 7 in the circumferential direction U, the second milling tool 31 removes one or more burrs at the transition from a surface O of the axial stop 5, which is aligned in the same direction as the radial direction R, into the first groove 7.

### REFERENCE NUMERALS

1 Rotor carrier
2 Flange connection portion
3 Receiving section
3A Connecting region
3B Receiving region
4 Laminated core holder
5 Axial stop
6 Positioning means
7 First groove
8 Second groove
20 Rotor device
21 Shaft
22 Flange means
23 Laminated core
24 Positioning means
30 First milling tool
31 Second milling tool
32 Rotation axis of the first milling tool
33 Rotation axis of the second milling tool
34 Step
AD Outer diameter of a laminated core holder
AS Outer side of the laminated core holder
A1 First distance between a bottom of the first groove and the rotation axis
A2 Second distance between a bottom of the second groove and the rotation
axis
B1 Bottom of the first groove
B2 Bottom of the second groove
D1 First width
D2 Second width
A Axial direction
R Radial direction
U Circumferential direction
O Surface of the axial stop
X Rotation axis of the rotor carrier

1. A rotor carrier for a rotor device of an electric machine of an electric or hybrid vehicle, having:
a flange connection portion for connection to a flange means of a shaft of the rotor device, and
a receiving section for laminated cores,
wherein the receiving section has a laminated core holder for non-rotatable arrangement of laminated cores and an axial stop for limiting a movement of the laminated cores in an axial direction (A),
wherein the receiving section has at least one positioning means for relative alignment of the laminated cores on the laminated core holder,
wherein the at least one positioning means has two grooves which are designed with different widths in a circumferential direction (U), and
wherein the two grooves are arranged so as to be aligned in the axial direction (A).

2. The rotor carrier according to claim 1,
wherein one of the two grooves, when viewed in the circumferential direction (U), has a first width (D1) and the other one of the two grooves, when viewed in the circumferential direction (U), has a second width (D2) and the first width is wider than the second width.

3. The rotor carrier according to claim 1,
wherein, when viewed in a radial direction (R), a first distance (A1) between a first bottom (B1) of one of the two grooves and a rotation axis (X) is greater than a second distance (A2) between a second bottom (B2) of the other one of the two grooves and the rotation axis (X).

4. The rotor carrier according to claim 1,
wherein a one of the two grooves of the at least one positioning means is arranged within the axial stop, and
wherein the one of the two grooves reduces an outer diameter (AD) of the laminated core holder of the receiving section of the rotor carrier by 0.05 to 0.5 mm, so that, in preparation for the other one of the two grooves, a plateau is created on an outer side (AS) of the laminated core holder, which, in comparison to the outer side (AS) of the laminated core holder, has a distance from a rotation axis (X), which is smaller by a burr created during production of the other one of the two grooves, so that deburring after production of the other one of the two grooves can be omitted.

5. A rotor device for an electric machine of an electric or hybrid vehicle, having:
the rotor carrier according to claim 1,
a shaft having a flange means for connection to the flange connection portion of the rotor carrier, and
a laminated core, having a positioning means for arrangement in a positioning means of the rotor carrier,
wherein the laminated core with its positioning means is arranged within a groove of the rotor carrier or within the positioning means of the rotor carrier, and
wherein the flange means of the shaft is connected to the flange connection portion of the rotor carrier.

6. An electric machine for an electric or hybrid vehicle having the rotor device according to claim 5 and a stator device surrounding the rotor device.

7. A method for producing a positioning means in a rotor carrier for an electric machine of an electric or hybrid vehicle, comprising:
positioning a first milling tool relative to the rotor carrier at initial coordinates in an axial direction (A) and a circumferential direction (U),
wherein a free end of the first milling tool is positioned at a first radial distance (A1) from a rotation axis (X) of the rotor carrier,
creating a first groove running in the axial direction (A) using the first milling tool,
wherein the first groove is formed within an axial stop of a receiving section of the rotor carrier or wherein the first forms a plateau on an outer side (AS) of a laminated core holder of the rotor carrier,
moving the first milling tool away from the rotor carrier,
changing the first milling tool to a second milling tool,
positioning the second milling tool relative to the rotor carrier at the initial coordinates of the first milling tool in the axial direction (A) and circumferential direction (U)
wherein the free end of the second milling tool is positioned at a second radial distance (A2) from the rotation axis (X) of the rotor carrier,
wherein the second radial distance (A2) is smaller than the first radial distance (A1),
creating a second groove running in the axial direction (A) using the second milling tool,
wherein the second groove is formed within the laminated core holder of the receiving section of the rotor carrier or wherein the second groove ends in the circumferential direction (U) and axial direction (A) within the first groove,
moving the second milling tool away from the rotor carrier.

8. The method according to claim 7,
wherein the first milling tool has a first diameter (D1) and the second milling tool has a second diameter (D2) and wherein the first diameter (D1) is larger than the second diameter (D2).

9. The method according to claim 7,
wherein, when creating the first and second grooves, the first and second milling tools are moved in the axial direction (A) along a same path, and
wherein, when creating the first and second groove the first and second milling tools approach a same end point in the circumferential direction (U) and axial direction (A), so that rotation axes of the milling tools end at the same coordinates in the circumferential direction (U) and axial direction (A), whereby, in a cross-section viewed in a radial and axial direction (R, A) through the positioning means of the rotor carrier, a step results in a transition from the first groove into the second groove.

10. The method according to claim 9,
deburring edges of the first or second groove using the second milling tool,
wherein, when deburring the first groove in the circumferential direction (U), the second milling tool removes one or more burrs at the transition from a surface (O) of the axial stop, which is aligned in a same direction as the radial direction (R), into the first groove.

11. A rotor carrier for a rotor of an electric machine, comprising:
a rotation axis;
a flange connection portion arranged for connecting to a rotor shaft;
a receiving section arranged for receiving laminated cores, the receiving section comprising:
a laminated core holder arranged for non-rotatably holding the laminated cores;
an axial stop arranged for limiting axial movement of the laminated cores; and
a positioning device for relative alignment of the laminated cores on the laminated core holder, the positioning device comprising:
a first groove comprising a first circumferential width; and
a second groove, axially aligned with the first groove and comprising a second circumferential width, different that the first circumferential width.

12. The rotor carrier of claim 11 wherein, when viewed in a radial direction a first distance between a bottom of the first groove and the rotation axis is greater than a second distance between a bottom of the second groove and the rotation axis.

13. The rotor carrier of claim 11, wherein:
the first groove is arranged within the axial stop; and
the first groove reduces an outer diameter of the laminated core holder by 0.05 mm to 0.5 mm to create a plateau on an outer side of the laminated core holder, the plateau comprising a distance from the rotation axis that is smaller than a distance from the outer side to the rotation axis by a burr created during production of the second groove; and
the second groove is not deburred.

14. A rotor device for an electric machine, comprising:
the rotor carrier of claim 11;
the rotor shaft connected to the flange connection portion; and
the laminated cores non-rotatably held in the laminated core holder, the laminated cores comprising respective positioning features arranged within the second groove.

15. An electric machine comprising:
the rotor device of claim 14; and
a stator device surrounding the rotor device.
